(19) United States
(12) Patent Application Publication
(10) Pub. No.: US 2026/0298422 A1
(43) Pub. Date: Oct. 1, 2026

(54) LINEAR LUMINAIRES AND DEVICES AND METHODS FOR CONNECTING LINEAR LUMINAIRES

(71) Applicant: Mindset Lighting, Inc., Port Coquitlam (CA)

(72) Inventors: Daniel FORTIN, New Westminster (CA); Greg Douglas, Edmonton (CA); Jordan Dery, Lanley (CA)

(21) Appl. No.: 19/634,687

(22) Filed: Mar. 31, 2026

Related U.S. Application Data
(60) Provisional application No. 63/780,820, filed on Mar. 31, 2025.

(51) Int. Cl. F21S 2/00; F21S 4/28; F21V 21/005; F21V 21/14; F21V 21/34; F21V 23/00; F21Y 105/10

(52) U.S. Cl. CPC F21S 2/005; F21S 4/28; F21V 21/005; F21V 21/14; F21V 21/34; F21V 23/002; F21Y 2105/10

(57) ABSTRACT

A connector for connecting two or more luminaires together comprises a base, a first hook provided at a first half of the base, a second hook provided at a second half of the base, a first cover detachably coupled to the first half of the base, and a second cover detachably coupled to the second half of the base. To connect first and second luminaires together using the connector, the first hook engages the first luminaire while the second hook engages the second luminaire. The first and second covers provide locking mechanisms for preventing movement of the base relative to the first and second luminaires when the locking mechanisms are activated.

### CROSS REFERENCE TO RELATED APPLICATIONS

This application claims the benefit under 35 U.S.C. § 119 of U.S. application No. 63/780,820 filed Mar. 31, 2025 and entitled LINEAR LUMINAIRES AND DEVICES AND METHODS FOR CONNECTING LINEAR LUMINAIRES, which is hereby incorporated herein by reference for all purposes.

### TECHNICAL FIELD

The present disclosure relates generally to luminaires, and in particular to linear luminaires and devices and methods for mechanically and electrically connecting two or more luminaires together to form an assembly of luminaires.

### BACKGROUND

Luminaires, also referred to as light fittings or light fixtures, are complete lighting units which include one or more light sources (e.g., lamps, bulbs, tubes, light emitting diodes (LEDs), etc.) and accessory components used for illuminating an environment. Examples of the types of accessory components that may be found in luminaires include sockets and other related parts for holding the light source in place, wiring for connecting the light source electrically to a power supply, and reflectors or other optical components for directing and distributing light emitted by light source(s) in a desirable manner.

Linear luminaires, also referred to as linear light fixtures, are generally elongated lighting devices designed to provide evenly distributed lighting over relatively large or open areas. The history of these types of luminaires can be traced back to the early 1900s with the development of fluorescent tubes. By the mid to late 1900s, linear luminaires had became widely adopted in both commercial and residential settings due to their energy efficiency over the incandescent lamps used at the time. With recent developments to LED technology, linear luminaires have become even more popular. Today, linear luminaires are designed to support a wide variety of LED configurations offering a broad range of light temperatures and color options. Modern linear luminaires can be surface-mounted, recessed, or even suspended from the ceiling, making them well suited for various architectural design needs.

Despite their growing popularity, linear luminaires are currently limited in their potential for design versatility due to the lack of a suitable device for connecting multiple luminaires together in different desired configurations. In order to satisfy electrical requirements (e.g., compliance with electrical codes), linear luminaires are usually connected end-to-end to form a continuous row. There are connectors available in the market that allow linear luminaires to be connected in other arrangements. However, these connectors are typically designed to accommodate connections at specific predefined angles only (i.e., 45°, 90°, 135°). In addition, some of these connectors are not designed to support the wiring or electrical connections required to power an entire assembly of linear luminaires (e.g., an entire row of linear luminaires connected together) from a common power source.

There remains a need for new and improved linear luminaires and devices capable of connecting two or more linear luminaires together in a wide range of angular orientations and spatial configurations. In particular, there remains a need for electro-mechanical connectors (i.e., connectors which provide or otherwise facilitate both electrical and physical connections) that are designed to form connections between two or more luminaires at locations that are preferably not visible from below (e.g., at locations above the luminaire fixture height). There remains a need for linear luminaires and luminaire connectors that are designed to allow the luminaires to be connected at unique angles to form distinctive lighting patterns. Such luminaire connectors should, preferably, be configurable to connect the linear luminaires at a wide range of angular relationships between connected luminaires, including highly acute angles (e.g., less than 30°), and/or to allow connections between linear luminaires to be formed with up to 180 degrees of freedom.

### SUMMARY

One aspect of the disclosure relates to a connector for connecting a first luminaire to a second luminaire. The connector comprises a base, a first cover detachably coupled to a first half of the base, and a second cover detachably coupled to a second half of the base. The base has a first hook for engaging the first luminaire, and a second hook for engaging the second luminaire. The first hook is located at the first half of the base, and the second hook located at the second half of the base. The first cover has a locking mechanism for preventing movement of the base relative to the first luminaire when the locking mechanism is activated. The second cover has a locking mechanism for preventing movement of the base relative to the second luminaire when the locking mechanism is activated.

In some embodiments, the first and second hooks extend below a bottom surface of the base. In some embodiments, the first and second hooks comprise protruding edges curved according to a curvature of curved tracks located at respective ends of the first and second luminaires. In some embodiments, the protruding edges are shaped to fit and slide within a groove within the curved tracks of the first and second luminaires. In some embodiments, the base comprises a cavity configured to house electrical wiring for forming an electrical connection between the first and second luminaires.

In some embodiments, the locking mechanism in provided by way of a friction fit between the hooks and the luminaires. In some embodiments, the covers comprise a tapered wedge, and the locking mechanism is provided by the tapered wedge and means for selectively restricting movement of the cover relative to the base. The tapered wedge of the cover and the hook of the base may extend in generally parallel directions when the cover is coupled to the base. The base may comprise tapered holes, and the cover may comprise a mounting surface for receiving a screw configured to restrict movement of the cover relative to the base. The first cover may be detachably mounted over the first half of the base, and the second cover may be detachably mounted over the second half of the base.

Another aspect of the disclosure relates to a connector having a base, a first hook, a second hook, a first cover, and a second cover. The base is shaped to define a cavity for routing electrical wiring and characterized as having a first half and a second half. The first hook is provided at the first half of the base and has a curved protruding edge configured to be received in an undercut groove of a curved track of a first luminaire. The second hook is provided at the second half of the base and has a curved protruding edge configured to be received in an undercut groove of a curved track of a second luminaire. The first cover is detachably coupled to the first half of the base. The first cover has a tapered locking wedge projecting from a bottom surface of the first cover. The second cover is detachably coupled to the second half of the base. The second cover has a tapered locking wedge projecting from a bottom surface of the second cover. With the base engaged with the first and second luminaires via the first and second hooks, the tapered locking wedge of the first cover is positioned between the first hook and an inner wall of the first luminaire to frictionally restrain sliding of the first hook along the curved track of the first luminaire, and the tapered locking wedge of the second cover is positioned between the second hook and an inner wall of the second luminaire to frictionally restrain sliding of the second hook along the curved track of the second luminaire.

Another aspect of the disclosure relates to a linear luminaire. The linear luminaire comprises a body portion extending in a longitudinal direction between the first and second end portions, one or more light sources supported by the body portion, and a track located at the first end portion.

Other aspects of the disclosure relate to lighting assemblies comprising linear luminaires of the type described herein that are connected to each other with one or more connectors of the type described herein.

In addition to the exemplary aspects and embodiments described above, further aspects and embodiments will become apparent by reference to the drawings and by study of the following detailed descriptions.

### BRIEF DESCRIPTION OF THE DRAWINGS

Various objects, features and advantages of the invention will be apparent from the following description of particular embodiments of the invention, as illustrated in the accompanying drawings in which:

FIG. 1 is a perspective view of a luminaire assembly according to an example embodiment.

FIG. 2 is a top view of the FIG. 1 luminaire assembly.

FIG. 3 shows two linear luminaires of a luminaire assembly connected end-to-end by a luminaire connector according to an example embodiment.

FIG. 4 shows two linear luminaires of a luminaire assembly connected end-to-body by a luminaire connectors according to an example embodiment.

FIG. 5 is a perspective view of a linear luminaire according to an example embodiment.

FIG. 6 is a cross sectional view of the FIG. 5 linear luminaire.

FIG. 7 shows the end portion of the FIG. 5 linear luminaire.

FIG. 8 is a perspective view of an example embodiment of a luminaire connector that may be used to connect two linear luminaires together.

FIG. 9 is a cross sectional view of the FIG. 8 luminaire connector connecting two linear luminaires together.

FIG. 10 shows the base of the FIG. 8 luminaire connector.

FIG. 11 shows the cap of the FIG. 8 luminaire connector.

FIG. 12 is a perspective view of an adjustable block of a linear luminaire according to an example embodiment.

### DETAILED DESCRIPTION

The description which follows and the embodiments described therein are provided by way of illustration of examples of particular embodiments of the principles of the present invention. These examples are provided for the purposes of explanation and not limitation of those principles and of the invention. In some instances, certain structures and techniques have not been described or shown in detail in order not to obscure the invention.

Aspects of the disclosure relate to linear luminaires and lighting fixtures with features which allow them to be connected together at a wide variety of connection points and angles to form unique design patterns. The features include end portions that are generally curved in shape, a curved track located at the end portions, and, optionally, a body portion with a repositionable block for providing its own curved track. Two or more of the luminaires described herein may be connected together using an electro-mechanical connector. For the purposes of facilitating the description, the term “electro-mechanical connector” is used herein to describe a connector that provides or otherwise facilitates both electrical and physical connections (i.e., electrical interconnection and mechanical coupling) between two or more luminaires.

The electro-mechanical connectors described herein include features that support movement of the connector along the curved tracks of the luminaires to thereby allow two or more luminaires to engage each other at a wide range of relative angular orientations. The connectors also include or otherwise provide locking features which are selectively operable to secure the connector in place against the luminaires. To adjust the angle or degree of pivot between the luminaires, the locking features may be released to allow the connector to move freely along the curved track(s). Once the luminaires have been pivoted to a desired angle, the locking features may be re-activated to hold the luminaires in place by restricting movement of the connector relative to the curved tracks. Together, the connectors and curved track designs allow multiple luminaires to be connected together into shapes and patterns that are not constrained by fixed or predefined angular relationships.

In some embodiments, the connector is designed to connect two linear luminaires together. In such embodiments, the connector may be characterized as comprising a first half with features for engaging and connecting to an end portion of a first luminaire and a second half with features for engaging and connecting to an end or body portion of a second luminaire. The first half of the connector may be generally symmetric to the second half of the connector. In such embodiments, the first half of the connector can facilitate pivoting of the first luminaire through up to 180°, and the second half of the connector can facilitate pivoting of the second luminaire through up to 180°. Together, the connector and the geometry of the luminaires allow the luminaries to be pivoted relative to each other with up to almost 360° of freedom. That is, the luminaires may be pivoted relative to each other to form a wide range of angles between them, including highly acute angles (e.g., less than 30°) and angles approaching 360°.

Other aspects of the invention relate to luminaire systems or assemblies comprising a plurality of linear luminaires connected to each other at various unique angles and locations to provide a desired architectural arrangement or lighting distribution for a space or environment. The luminaire assembly may be suspended from the ceiling in some cases. The luminaires of the assembly may be powered from a common power source, with the connectors providing the required mechanical support and facilitating the required electrical connections between the luminaires. Each luminaire assembly may comprise any suitable number of luminaires (e.g., 2, 3, 4, 5 or more) and connectors.

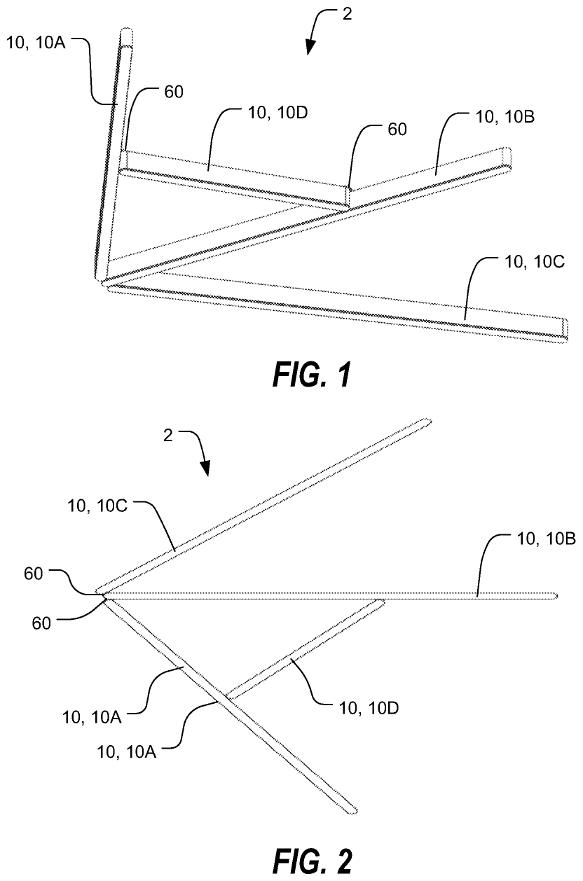

FIG. 1 shows an example embodiment of a luminaire assembly 2. Luminaire assembly 2 comprises four linear luminaires 10 connected to each other at different angles and connection locations via connectors 60. In the illustrated embodiment, first and second linear luminaires 10A, 10B are connected to each other at one of their respective ends via a first connector 60. A third luminaire 10C is connected at one of its ends to the same end of second luminaire 10B via a second connector 60.

For the purposes of facilitating the description, luminaires 10A, 10B, 10C may be described herein as being connected to each other at a common “node”, wherein a “node” is defined as a general point or area at which two or more luminaires contact or intersect each other. Because of the geometry of luminaires 10 at their ends, three (or even more) luminaires may be connected to each other at a common node as shown in FIG. 2. In the illustrated embodiment, the luminaires 10A, 10B are connected to each other at a common node to form an acute angle between them, and luminaires 10B, 10C are connected to each other at the same common node to form an acute angle between them. Other angles may be formed between two or more luminaires 10 in other embodiments.

As described in more detail below, linear luminaires 10 include features which support interconnection and allow nodes to be formed at their body portions (i.e., the elongated part of the luminaire) in addition to at their end portions. In the illustrated embodiment, a fourth linear luminaire 10D comprises a first round end portion that is connected to a body portion of first linear luminaire 10A via a third connector 60 and an opposing second round end portion that is connected to a body portion of second linear luminaire 10B via a fourth connector 60. As depicted in FIG. 2, fourth linear luminaire 10D is shorter in length compared to the other linear luminaires to allow the body portion connections to be formed. In general, luminaire assembly 2 may comprise a variety of linear luminaires 10 with different lengths or sizes.

Connectors 60 are capable of connecting any two linear luminaires 10 in assembly 2 together (e.g., either end-to-end like how luminaires 10A, 10B are connected, or end-to-body like how luminaires 10A, 10D are connected), regardless of their lengths or sizes. This, advantageously, promotes modularity in design and allows a wide variety of luminaire assembly patterns to be formed using common components. For example, a number of different linear luminaires 10 (e.g., luminaires of different lengths or sizes) and identical connectors 60 may be provided in a kit in some embodiments and provided to a designer to create their own unique luminaire assembly 2. Since the same identical connector 60 is compatible with different luminaires 10, different types of kits can be put together relatively quickly, and a large number of luminaire designs can be created from each kit.

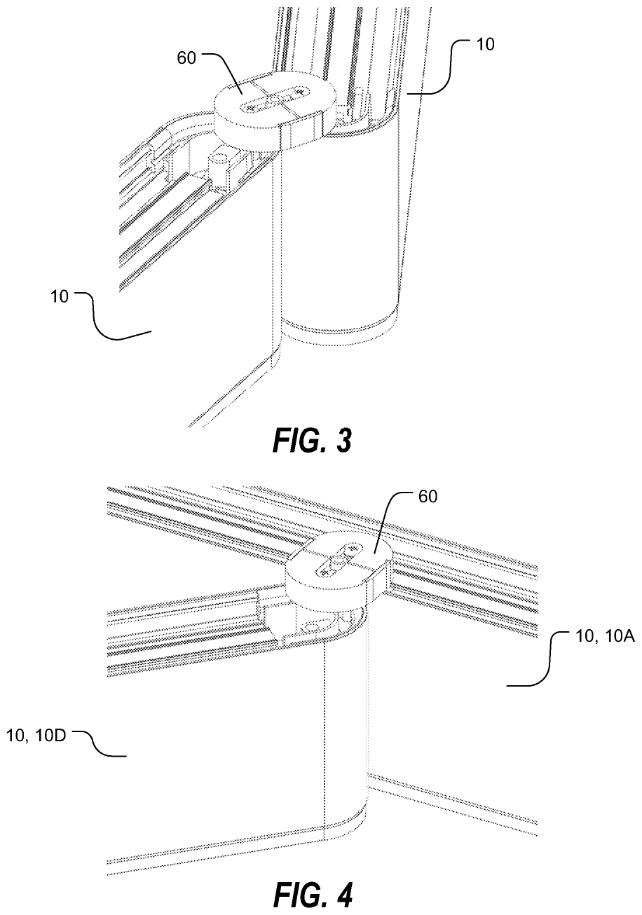

FIG. 3 shows two luminaires 10 that are connected to each other at their respective end portions via connector 60. For the purposes of facilitating the description, these types of connections are referred to herein as “end-to-end” connections. FIG. 4 shows two luminaires 10 that are connected to each other at a body portion of a first luminaire 10A and an end portion of a second luminaire 10D via connector 60. For the purposes of facilitating the description, these types of connections are referred to herein as “end-to-body” or “body-to-end” connections. As depicted in FIGS. 3 and 4, the same connector design can be used to facilitate both end-to-end connections and end-to-body connections in luminaire assembly 2.

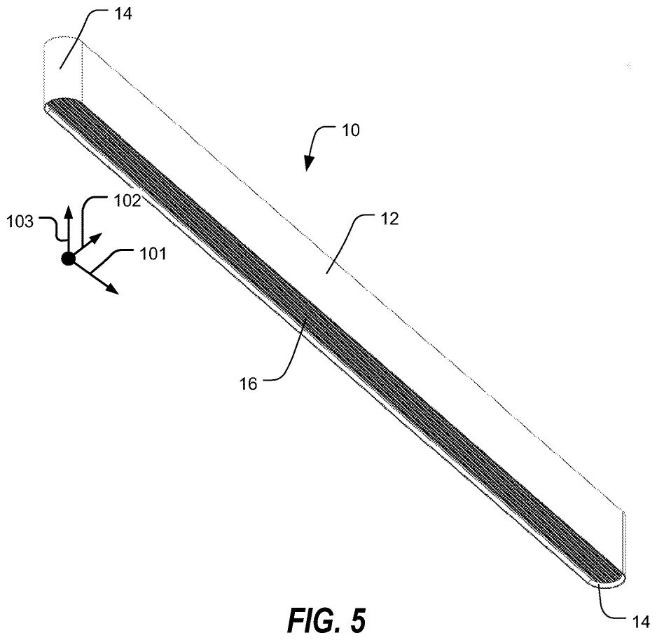

FIG. 5 shows a linear luminaire 10 according to an example embodiment. Luminaire 10 comprises a body portion 12 extending between opposing end portions 14. Body portion 12 may be characterized with a length dimension defined in a longitudinal direction 101, a width dimension defined in a first transverse direction 102, and a height dimension defined in a second transverse dimension 103. As depicted in FIG. 5, body portion 12 is typically elongated (i.e., body portion 12 typically has a length that is greater than its width and height). Body portion 12 may, for example, have a length in the range of 2 feet to 12 feet, a width in the range of 1 inch to 6 inches, and a height in the range of 2 inches to 6 inches. Other dimensions are possible within the scope of this disclosure.

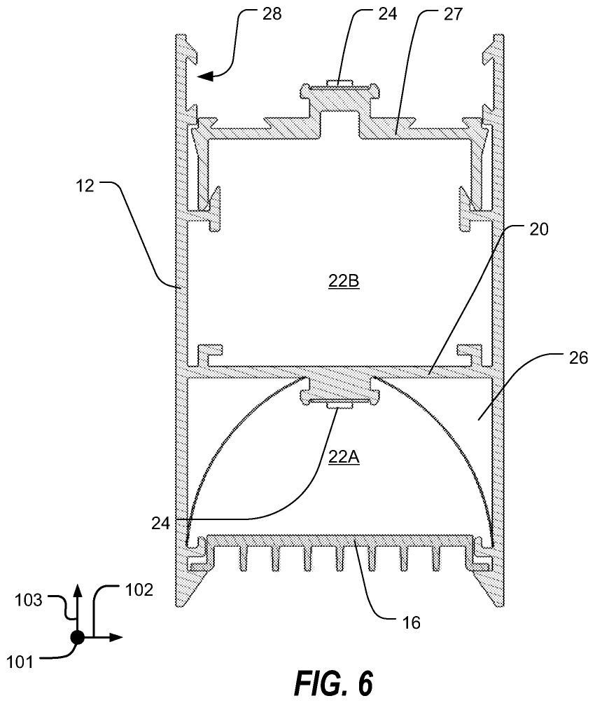

Body portion 12 comprises one or more housings for holding or storing the light sources (e.g. light emitting diodes (LEDs), lamps, bulbs, tubes, etc.) and accessory components of luminaire 10, including wiring for connecting the light source electrically to a power supply, reflectors, and other optical components for directing and distributing light emitted by the light sources in a desirable manner. In the illustrated embodiment of FIG. 6, body portion 12 has a wall 20 which partitions body portion 12 into a lower housing 22A and an upper housing 22B. Lower housing 22A holds, stores, or otherwise accommodates the light sources and optical components required to provide direct lighting to an area beneath luminaire 10. Upper housing 22B holds, stores, or otherwise accommodates the electrical components (e.g., wiring, control panels, etc.) required to power the light sources. Upper housing 22B may, optionally, also hold, store, or otherwise accommodate the light sources and optical components required to provide indirect lighting to or within a surrounding environment (e.g., the area beneath luminaire 10).

In the illustrated embodiment, LEDs 24 are supported or otherwise provided at the top of lower housing 22A (e.g., mounted to a bottom surface of wall 20). LEDs 24 may be provided in the form of one or more LED strips extending in longitudinal direction 101. A reflector 26 is disposed around LEDs 24 to direct the light emitted by LEDs 24 in a desired manner. Reflector 26 may be parabolic or concave in shape as depicted in FIG. 6 and may also extend in longitudinal direction 101. This can help luminaire 10 provide good direct lighting to an area below the luminaire. One or more lenses 16 may, optionally, be provided in lower housing 22A to help control and distribute the light emitted from LEDs 24 in a desired manner. Lenses 16 may be ribbed as shown in FIG. 6 or shaped in other desirable geometries (e.g.,. biconcave, biconvex, plano concave, plano convex, wide-angled, etc.). Like LEDs 24 and reflector 26, lens 16 may extend in longitudinal direction 101.

Additional LEDs 24 may, optionally, be provided in upper housing 22B to provide indirect lighting. In the illustrated embodiment, additional LEDs 24 are mounted on and supported by a top lid 27 of luminaire 10. Lid 27 may be detachably coupled to or mounted over body portion 12. Lid 27 may fit snugly against the walls of body portion 12 to enclose the electrical components (e.g., wiring, panels, etc.) stored in upper housing 22B. As shown in FIG. 6, the LEDs 24 of upper housing 22B may be oriented in a direction that is generally opposite to the direction of the LEDs 24 of lower housing 22A, thereby providing indirect lighting to a surrounding space or surface (e.g., the area underneath luminaire 10). Like lower housing 22A, upper housing 22B may, optionally, hold, store, or otherwise accommodate optical components (not shown) to help direct the light emitted by upper LEDs 24 in a desired manner.

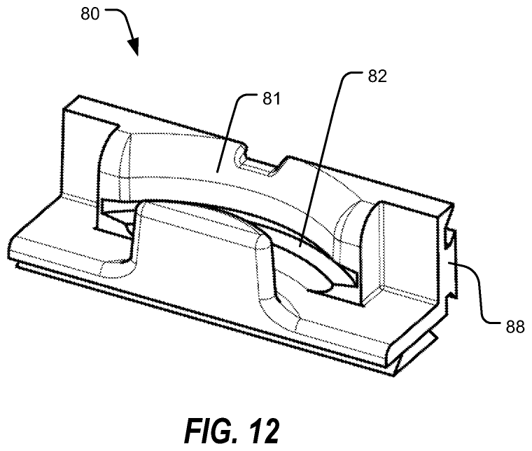

In some embodiments, body portion 12 comprises rails 28 located at the top of upper housing 22B. Rails 28 may extend in longitudinal direction 101. As shown in FIG. 6, rails 28 may be formed or located at the inner upper parts of each of the opposing side walls of body portion 12. Rails 28 may be shaped or otherwise configured to support a repositionable block 80 (e.g., see FIG. 12). As described in more detail below, the block comprises a curved track that is designed or otherwise configured to facilitate end-to-body connections with other luminaires 10 through connector 60.

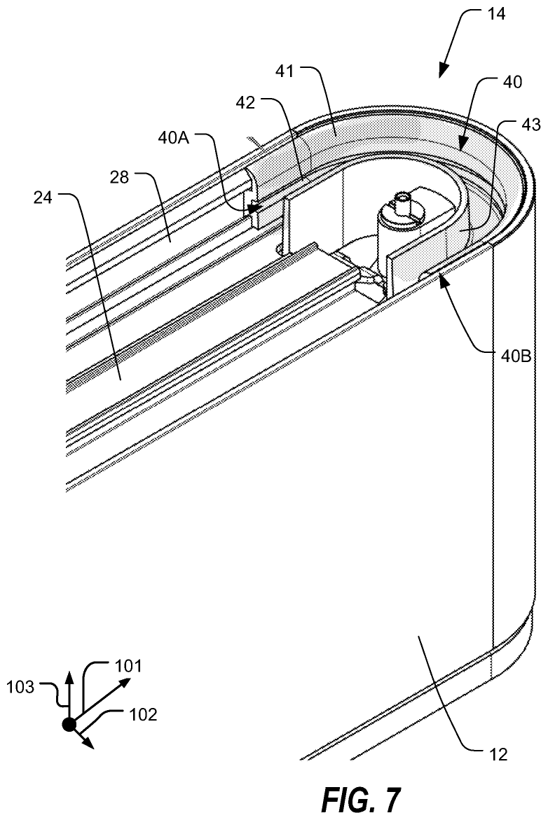

End portions 14 are characterized as being located at opposing longitudinal ends of body portion 12. End portion 14 comprises a curved track 40 or other structure configured to allow connector 60 to engage luminaire 10 and be secured in place at various different angles (i.e., means for selectively facilitating movement of connector 60 relative to luminaire 10). Track 40 may be defined by a curved outer wall 41 and a curved inner wall 43 of end portion 14 as shown in FIG. 7. The curvature of track 40 may lie notionally in a plane defined by longitudinal direction 101 and transverse direction 102 (i.e., the plane defined by the length and width of the luminaire). In some embodiments, curved outer wall 41 (or a portion thereof) is provided by a semi-cylindrical shell shaped component that is detachable from the rest of luminaire 10.

Track 40 is designed or otherwise configured to facilitate various end-to-end or end-to-body connections with other luminaires 10 via connector 60. To facilitate these connections, connector 60 may move freely within track 40 and may be secured in place (e.g., secured at a certain position within the track) via a locking mechanism. Depending on where connector 60 is positioned and secured along track 40, various different angles may be formed between two linear luminaires 10 that are connected together through connector 60. In some embodiments, track 40 comprises groove 42 that is configured to receive or otherwise engage a hook of connector 60. Groove 42 may be provided in the form of a tapered undercut slot extending around outer wall 41 as shown in FIG. 7. The hook of connector 60 may be provided in the form of a curved protruding edge, as described in more detail below.

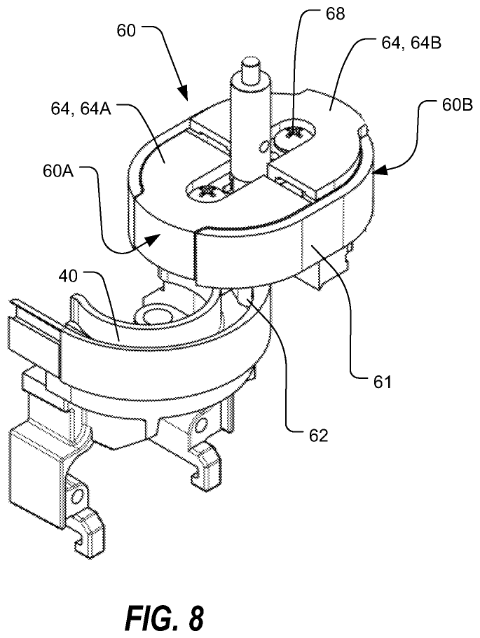

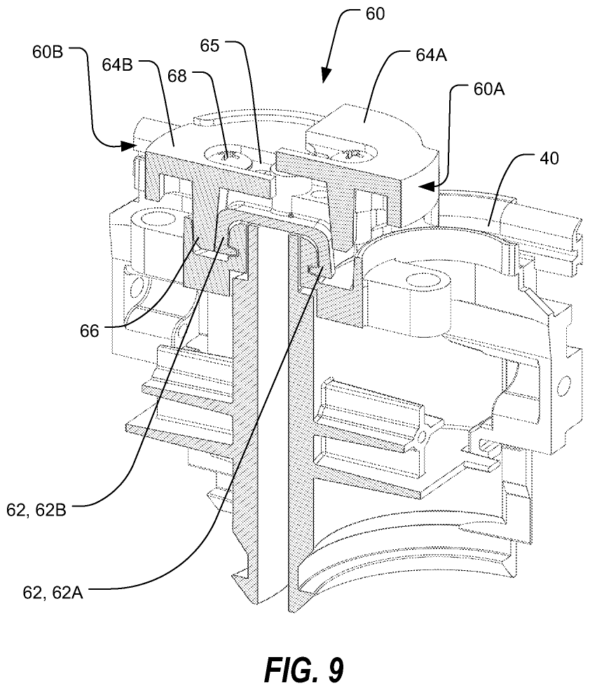

Referring now to FIGS. 8 and 9, shown therein is a connector 60 according to one example embodiment. Connector 60 comprises a base 61 and two covers 64 that may be mounted over or otherwise detachably coupled to base 61. As described above, connector 60 may be characterized as having generally symmetric first and second halves 60A, 60B. A first cover 64A may be mounted over base 61 at first half 60A, and a second cover 64B may be mounted over base 61 at second half 60B. First half 60A may support or otherwise provide structure configured to engage and connect to a first linear luminaire 10 (e.g., luminaire 10A in FIG. 1), and second half 60B may support or otherwise provide structure configured to engage and connect to a second linear luminaire 10 (e.g., luminaire 10B in FIG. 1). The structure configured to engage and connect to a linear luminaire 10 include a mechanism for allowing linear luminaire 10 to pivot relative to connector 60 and a locking mechanism for holding linear luminaire 10 in place once it has been pivoted to a desirable angle or orientation.

In the illustrated embodiment, the pivoting mechanism is provided by hook 62 extending below the bottom of base 61. Hook 62 is curved in accordance with the curvature of groove 42, thereby allowing it to slide continuously along groove 42. In some embodiments, connector 60 comprises two hooks 62. A first hook 62A is located at first half 60A of connector 60, and a second hook 62B is located at second half 60B of connector 60. When connector 60 is used to connect two luminaires 10 together, the first hook 62A fits within and is slidable along groove 42 of a first linear luminaire 10, and the second hook 62B fits within and is slidable along groove 42 of a second linear luminaire 10.

When hook 62 is moved to a first end 40A of track 40, linear luminaire 10 may be considered to be in a 0° position relative to connector 60. When hook 62 is moved to a second end 40B of track 40, linear luminaire 10 may be considered to be in a 180° position relative to connector 60. Connector 60 may, through hook 62, move or slide anywhere between the two ends of track 40. This allows linear luminaire 10 to pivot freely relative to connector 60 with close to 180 degrees of freedom. With two hooks 62 (i.e., a first hook hanging beneath a first half 60A of connector 60 for connecting to a first luminaire, and a second hook hanging beneath a second half 60B of connector 60 for connecting to a second luminaire), each connector 60 may be used to connect two linear luminaires 10 together at, for example, their respective ends with close to 360 degrees of freedom.

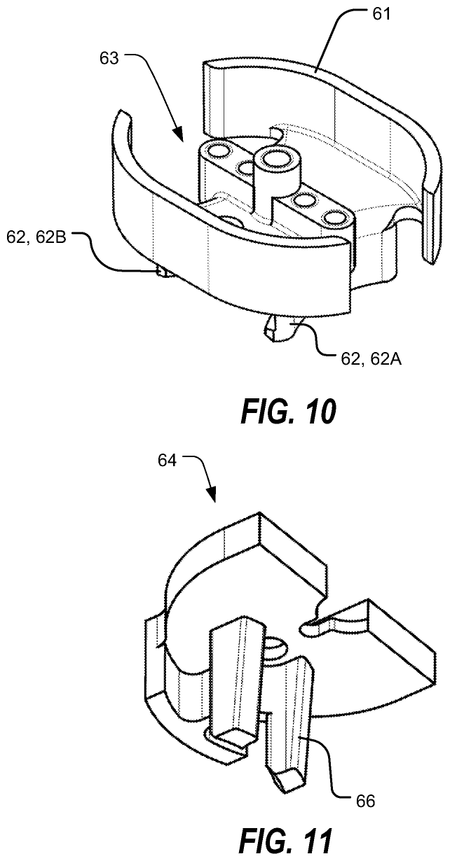

In the illustrated embodiment, the locking mechanism is provided by a locking wedge 66 of cover 64. Locking wedge 66 is tapered in shape and insertable into track 40 to prevent movement of hook 62 within groove 42. Locking wedge 66 may be tapered and point toward transverse direction 103 when it is inserted into track 40. When base 61 is inserted into track 40 and when cover 64 is mounted over base 61, locking wedge 66 fits snugly between a back portion of hook 62 and inner wall 43 of luminaire 10 to restrict movement of base 61 by way of friction. To prevent movement of wedge 66 when it has been inserted in track 40, cover 64 may be fastened or otherwise secured against base 61. This prevents cover 64 and wedge 66 from moving relative to base 61 and hook 62, thereby securing connector 60 in place against luminaire 10. In the illustrated embodiment, a mounting screw 68 is used to secure cover 64 against base 61. To facilitate the connection between base 61 and cover 64, base 61 may have tapered holes and cover 64 may have a mounting surface 65 as shown in FIGS. 9 and 10. The tapered connection may be formed by mounting cap 64 over base 61, and threading screw 68 through cover 64 and into the tapered hole of base 61 so that the bearing surface of the mounting screw 68 engages mounting surface 65 of cap 64.

Base 61 may be shaped to provide a space for allowing electrical wiring to pass through. This feature allows two luminaires 10 physically connected through connector 60 to be powered by the same electrical system. As depicted in FIG. 10, base 61 may comprise a cavity 63 located above hooks 62 that is large enough to allow a plurality of wires (e.g., Ground, Line, Neutral, Control 1, Control 2, etc.) to pass through. In such embodiments, connector 60 may facilitate both a mechanical connection and an electrical connection between two luminaires 10. An electrical ground (not shown) may optionally be provided within cavity 63 in some embodiments to help improve safety.

As described above, the same identical connector 60 may be used to facilitate both end-to-end connections and end-to-body connections in luminaire assembly 2. To facilitate end-to-body connections, some of the linear luminaires 10 of assembly 2 comprise a block 80 that is movable along body portion 12 of linear luminaire 10. Like how the same design for connector 60 can be used to form various end-to-end and end-to-body connections, the same design for block 80 can be used with luminaires of different dimensions, thereby promoting modularity in design. In the illustrated example, block 80 comprises a support member 88 for insertion in rail 28 of luminaire 10. When support member 88 is inserted in rail 28, block 80 is coupled to body portion 12 and slidable in longitudinal direction 101 along the length of luminaire 10.

Like end portion 14, block 80 comprises a curved track 81 or other structure configured to allow connector 60 to be secured at various different angles relative to block 80. In contrast to track 40 which has a radius of curvature facing longitudinal direction 101, track 81 has a radius of curvature facing transverse direction 102 when block 80 is coupled to body portion 12. Track 81 may be defined by curved inner and outer walls and may comprise a curved groove 82 as shown in FIG. 12. The curved inner and outer walls defining track 81 may be shaped in accordance with the curvature of hook 62. Groove 82 is shaped or otherwise configured accordingly to receive hook 62 of connector 60 at various different angles. That is, connector 60 may be pivoted to form various different angles relative to body portion 12 depending on the position hook 62 within groove 82. In some embodiments, the curvature of track 81 is the same as the curvature of track 40. In some embodiments, the length of track 81 is shorter than the length of track 40.

To form an end-to-body connection between two linear luminaires 10 using connector 60, an end portion 14 of a first luminaire 10 may be connected to first half 60A of connector 60 by way of first hook 62A and track 40, while body portion 12 of a second luminaire 10 may be connected to second half 60B of connector 60 by way of second hook 62B and track 81. To form an end-to-end connection between two linear luminaires 10 using connector 60, an end portion 14 of a first luminaire 10 may be connected to first half 60A of connector 60 by way of first hook 62A and track 40 of the first linear luminaire 10, while an end portion 14 of a second luminaire 10 may be connected to second half 60B of connector 60 by way of second hook 62B and track 40 of the second linear luminaire 10. Various end-to-end and end-to-body connections may be formed between a plurality of luminaires 10 to form different luminaire assemblies 2.

Illustratively, linear luminaires of the type described herein may be connected together in a large variety of ways to create unique patterns. The rounded end design of the linear luminaires allows them to be connected together at almost any angle, including highly acute angles (i.e., less than 30° between two linear luminaires), and in a wide variety of configurations. Connectors of the type described herein are also designed to facilitate greater freedom of luminaire placement.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by skilled persons that other variants and modifications may be made without departing from the scope of the invention as defined in the claims appended hereto. The scope of the claims should not be limited by the preferred embodiments and examples, but should be given the broadest interpretation consistent with the description as a whole.

### Interpretation of Terms

The terms “including”, “comprising” and variations thereof mean “including but not limited to” unless expressly specified otherwise. “Connected”, “coupled” or any variant thereof means any connection or coupling, either direct or indirect, between two or more elements; the coupling or connection between the elements can be physical, mechanical, electrical, or a combination thereof. “Herein”, “above”, “below” and words of similar import, when used to describe this specification shall refer to this specification as a whole and not to any particular portions of this specification. “Or” in reference to a list of two or more items, covers all of the following interpretations of the word: any of the items in the list, all of the items in the list, and any combination of the items in the list. A listing of items does not imply that any or all of the items are mutually exclusive, unless expressly specified otherwise. The terms “a”, “an”, and “the” mean “one or more”, unless expressly specified otherwise.

The terms “an embodiment”, “embodiment”, “embodiments,”, “the embodiment”, “the embodiments”, “one or more embodiments”, “some embodiments”, and “one embodiment” mean “one or more (but not all) embodiments of the present invention(s)” unless expressly specified otherwise.

Where a component is referred to above, unless otherwise indicated, reference to that component should be interpreted as including as equivalents of that component any component which performs the function of the described component (i.e., that is functionally equivalent), including components which are not structurally equivalent to the disclosed structure which performs the function in the illustrated exemplary embodiments of the invention.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it should be understood that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Although the present invention has been described and illustrated with respect to preferred embodiments and preferred uses thereof, it is not to be so limited since modifications and changes can be made therein which are within the full, intended scope of the invention as understood by those skilled in the art.

1. A connector for connecting first and second luminaires with a curved track provided at one or more of their respective ends, the connector comprising:
a base;
a first hook provided at a first half of the base for engaging the curved track of the first luminaire;
a second hook provided at a second half of the base for engaging the curved track of the second luminaire;
a first cover detachably coupled to the first half of the base, the first cover having a locking mechanism for preventing movement of the base relative to the first luminaire when the locking mechanism is activated; and
a second cover detachably coupled to the second half of the base, the second cover having a locking mechanism for preventing movement of the base relative to the second luminaire when the locking mechanism is activated.

2. The connector of claim 1, wherein the first hook and the second hook extend below a bottom surface of the base.

3. The connector of claim 2, wherein the first hook and the second hook each comprise a curved protruding edge, and wherein the curved protruding edge has a curvature corresponding to a curvature of the curved tracks of the first and second luminaires.

4. The connector of claim 3, wherein the protruding edges are shaped to fit within and slide along a tapered undercut groove formed within the curved tracks of the first and second luminaires.

5. The connector of claim 1, wherein the base comprises a cavity sized to permit routing of a plurality of wires through the base between the first luminaire and the second luminaire.

6. The connector of claim 5, wherein the locking mechanism comprises a tapered wedge projecting from a bottom surface of the cover.

7. The connector of claim 6, wherein the locking mechanism is activated upon insertion of the cover into the cavity to position the tapered locking wedge between the hook and an inner wall of the luminaire.

8. The connector of claim 7, wherein the tapered wedge of the covers and the hook of the base extend in generally parallel directions when the cover is coupled to the base.

9. The connector of claim 7, wherein the cover comprises a mounting surface and one or more holes for receiving a fastener configured to restrict movement of the cover relative to the base.

10. The connector of claim 1, wherein the first cover is detachably mounted over the first half of the base, and wherein the second cover is detachably mounted over the second half of the base.

11. A linear luminaire comprising:
a body portion extending in a longitudinal direction between a first end portion and a second end portion;
one or more light sources provided at the body portion; and
a curved track provided at the first end portion,
wherein the curved track is configured to extend between a first end located at a first side of the body portion to a second end located at a second side of the body portion to facilitate movement of a connector between the first and second ends of the curved track.

12. The linear luminaire of claim 11, comprising a second curved track provided at the second end portion, wherein the second track is configured to extend between a first end located at a first side of the body portion to a second end located at a second side of the body portion to facilitate movement of a connector between the first and second ends of the curved second track.

13. The linear luminaire of claim 11, wherein the curved track is defined by a curved outer wall and a curved inner wall of the first end portion.

14. The linear luminaire of claim 13, wherein the curved track comprises a groove shaped to receive a curved protruding edge of the connector.

15. The linear luminaire of claim 14, wherein the groove is provided in the form of a tapered undercut slot extending around the curved outer wall of the first end portion.

16. The linear luminaire of claim 11, comprising a block movable along the body portion, the block having a partial curved track having a curvature corresponding to a curvature of the curved track.

17. The linear luminaire of claim 10, comprising a wall dividing the body portion into an upper housing and a lower housing.

18. The linear luminaire of claim 17, comprising one or more light sources provided in the lower housing.

19. The linear luminaire of claim 18, comprising one or more light sources provided in the upper housing.

20. A connector for connecting a first luminaire to a second luminaire, the connector comprising:
a base defining a cavity for routing electrical wiring;
a first hook provided at a first half of the base, the first hook having a curved protruding edge configured to be received in an undercut groove of a curved track of the first luminaire;
a second hook provided at a second half of the base, the second hook having a curved protruding edge configured to be received in an undercut groove of a curved track of the second luminaire;
a first cover detachably coupled to the first half of the base, the first cover having a tapered locking wedge projecting from a bottom surface of the first cover; and
a second cover detachably coupled to the second half of the base, the second cover having a tapered locking wedge projecting from a bottom surface of the second cover,
wherein, with the base engaged with the first and second luminaires via the first and second hooks and with the first and second covers coupled to the first and second halves of the base, the tapered locking wedge of the first cover is positioned between the first hook and an inner wall of the first luminaire to frictionally restrain sliding of the first hook along the curved track of the first luminaire, and the tapered locking wedge of the second cover is positioned between the second hook and an inner wall of the second luminaire to frictionally restrain sliding of the second hook along the curved track of the second luminaire.
